(19) United States
(12) Patent Application Publication
(10) Pub. No.: US 2021/0059267 A1
(43) Pub. Date: Mar. 4, 2021

(54) TENDON REMOVING TOOL

(71) Applicants: Christopher Neilson, Port St. Lucie, FL (US); Alexander M. Green, III, Astoria, NY (US)

(72) Inventors: Christopher Neilson, Port St. Lucie, FL (US); Alexander M. Green, III, Astoria, NY (US)

(21) Appl. No.: 16/554,909

(22) Filed: Aug. 29, 2019

(51) Int. Cl. A22C 21/00

(52) U.S. Cl. CPC A22C 21/00

(57) ABSTRACT

A tendon removing tool includes a handle and a blade. The blade includes a proximal end extending from the handle and a head at a distal end. The head includes a front edge and a U-shaped inner edge defining a U-shaped slot. The U-shaped inner edger includes inner side edges joined by an inner bend. The inner side edges define a gap at the front edge leading into the U-shaped slot.

### BACKGROUND OF THE INVENTION

The present invention relates to removal of a tendon from chicken tenders and, more particularly, to a tool for removing the tendon from chicken tenders.

Chicken tenders are chicken meat prepared from the pectoralis minor muscles of the animal. These strips of white meat are located on either side of the breastbone, under the breast meat. A tendon runs through the chicken tenders, which causes the chicken tender to be tough when consumed. The tendon is difficult to remove from the chicken tender.

As can be seen, there is a need for a tool for removing the tendon from chicken tenders.

### SUMMARY OF THE INVENTION

In one aspect of the present invention, a tendon removing tool comprises: a handle; and a blade comprising a proximal end extending from the handle and a head at a distal end, wherein the head comprises a front edge and a U-shaped inner edge defining a U-shaped slot and comprising inner side edges joined by an inner bend, wherein the inner side edges define a gap at the front edge leading into the U-shaped slot.

In another aspect of the present invention, a method of removing a tendon from a chicken tender comprises: providing a tool comprising a blade having a front edge and a U-shaped inner edge defining a U-shaped slot and comprising inner side edges joined by an inner bend, wherein the inner side edges defines a gap at the front edge leading into the U-shaped slot; separating an end of the tendon from the chicken tender; placing the end through the U-shaped slot and against the inner bend; and pulling the tendon against the bend, through the U-shaped slot, and out of the chicken tender.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a section view of the present invention, taken along line 2-2 in FIG. 1;

FIG. 3 is a perspective view of an embodiment of the present invention, shown in use; and

FIG. 4 is a perspective view of an embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

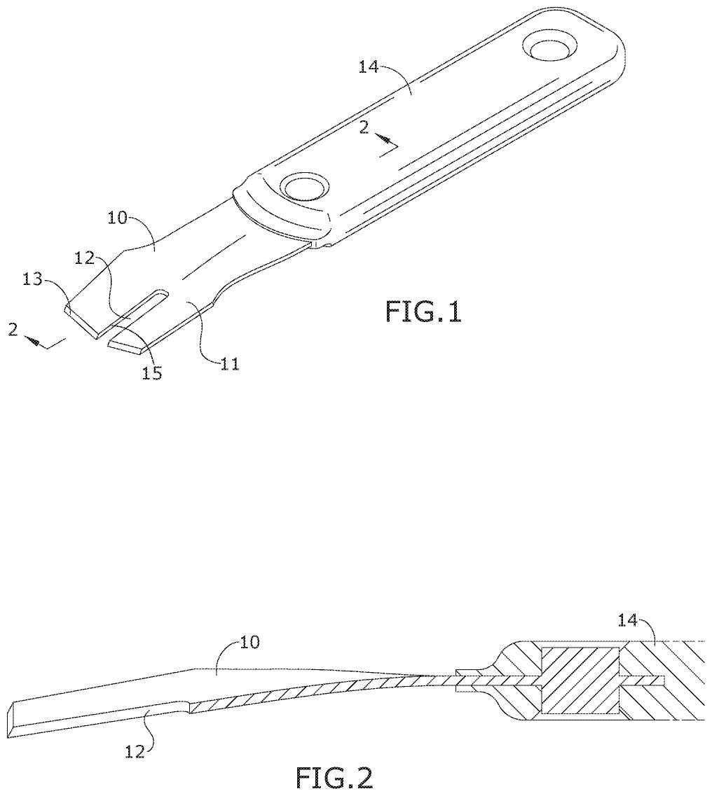

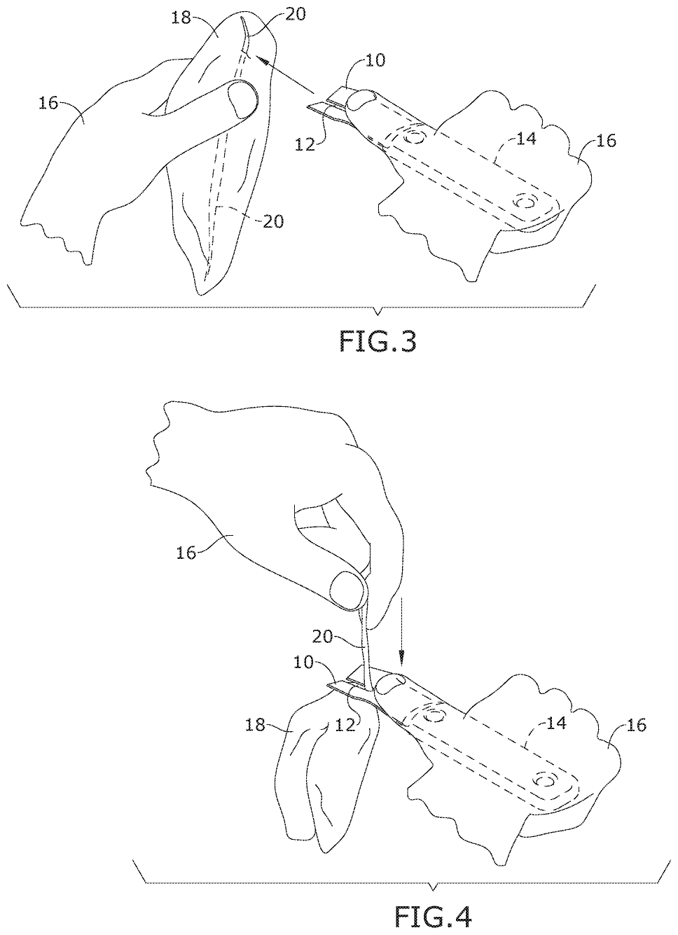

Referring to FIGS. 1 through 4, the present invention includes a tendon removing tool. The tendon removing tool includes a handle 14 and a blade 10. The blade 10 includes a proximal end extending from the handle 14 and a head 11 at a distal end. The head 11 includes a front edge 13 and a U-shaped inner edge 15 defining a U-shaped slot 12. The U-shaped inner edger 15 includes inner side edges joined by an inner bend. The inner side edges define a gap at the front edge leading into the U-shaped slot 12.

The blade 10 of the present invention may be made of a rigid plastic or a metal. In certain embodiments, portions of the blade 10 may be tapered and sharpened. For example, the front edge 13 may be sharpened to make an initial cut in the chicken tender 18 and separate an end of the tendon 20 from the chicken. Additionally, the inner bend may be sharpened to easily separate the tendon from the chicken when pulling the tendon through the U-shaped slot 12.

As mentioned above, the head 11 of the present invention includes the portion of the blade 10 including the front edge 13 and the U-shaped slot 15. In certain embodiments, the U-shaped slot 15 is elongated and separates the head into a first wing and a second wing. The first wing and the second wing are at an angle relative to one another, allowing the user to dig into the chicken to initially extract the end of the tendon. The first wing and the second wing may have a V-shaped cross section.

A method of removing a tendon 20 from a chicken tender 18 by a user 16 includes the following steps. Provide the tool described above. Separate an end of the tendon 20 from the chicken tender 18 by digging the front edge 13 of the blade 11 into the chicken tender 18. Pull and place the end of the tendon 20 through the U-shaped slot and against the inner bend so that the chicken tender 18 is hanging underneath the blade 10. Pull the tendon 20 against the bend, through the U-shaped slot 12, and out of the chicken tender 18.

It should be understood, of course, that the foregoing relates to exemplary embodiments of the invention and that modifications may be made without departing from the spirit and scope of the invention as set forth in the following claims.

What is claimed is:

1. A tendon removing tool comprising:
a handle; and
a blade comprising a proximal end extending from the handle and a head at a distal end, wherein
the head comprises a front edge and a U-shaped inner edge defining a U-shaped slot and comprising inner side edges joined by an inner bend, wherein the inner side edges define a gap at the front edge leading into the U-shaped slot.

2. The tendon removing tool of claim 1, wherein the front edge is sharpened.

3. The tendon removing tool of claim 1, wherein the blade is made of metal or a rigid plastic.

4. The tendon removing tool of claim 1, wherein the U-shaped slot is elongated.

5. The tendon removing tool of claim 1, wherein the U-shaped slot separates the head into a first wing and a second wing, wherein the first wing and the second wing are at an angle relative to one another.

6. A method of removing a tendon from a chicken tender comprising:
providing a tool comprising a blade having a front edge and a U-shaped inner edge defining a U-shaped slot and comprising inner side edges joined by an inner bend, wherein the inner side edges defines a gap at the front edge leading into the U-shaped slot;
separating an end of the tendon from the chicken tender;
placing the end through the U-shaped slot and against the inner bend; and
pulling the tendon against the bend, through the U-shaped slot, and out of the chicken tender.

7. The method of claim 6, wherein the front edge is sharpened.

8. The method of claim 6, wherein the blade is made of metal or a rigid plastic.

9. The method of claim 6, wherein the U-shaped slot is elongated.

10. The method of claim 6, wherein the U-shaped slot separates the blade into a first wing and a second wing, wherein the first wing and the second wing are at an angle relative to one another.
